(19) United States
(12) Patent Application Publication
(10) Pub. No.: US 2019/0358641 A1
(43) Pub. Date: Nov. 28, 2019

(54) SHEET SUPPLY DEVICE, SHREDDING DEVICE, WEB FORMING DEVICE, AND SHEET RECYCLING SYSTEM

(71) Applicant: SEIKO EPSON CORPORATION, Tokyo (JP)

(72) Inventor: Takashi ABE, Sakata (JP)

(21) Appl. No.: 16/416,334

(22) Filed: May 20, 2019

(30) Foreign Application Priority Data
May 22, 2018 (JP) 2018-097864

(51) Int. Cl. B02C 18/00; B02C 18/22

(52) U.S. Cl. CPC B02C 18/0007; B02C 2018/2208; B02C 18/2283

(57) ABSTRACT

A sheet supply device, a shredding device, a web forming device, and a sheet recycling system enabling smoothly supplying sheets regardless of the size and type of the sheets, and reducing equipment size. The sheet supply device includes a tray having a support surface on which a sheet is placed; a supplier configured to feed the sheet placed on the support surface; and a discharger from which the sheet is discharged by operation of the supplier. The supplier has multiple rollers disposed separated in the feed direction of the sheet; a rotation driver configured to rotationally drive the multiple rollers; and a roller support supporting the rollers in a direction to and away from the support surface. The sheet placed on the support surface contacts at least one of the multiple rollers and is fed to the discharger by displacement of the roller support.

### BACKGROUND

### 1. Technical Field

The present invention relates to a sheet supply device, a shredding device, a web forming device, and a sheet recycling system.

### 2. Related Art

Systems having a supply device for supplying recovered paper and other types of previously used paper to a shredder, and cutter elements for shredding paper supplied from the supply device, are known from the literature. See, for example, U.S. Pat. No. 9,669,411. The supply device in the system described in U.S. Pat. No. 9,669,411 has an arm supported so that it can rotate 360 degrees, and feeds the paper toward the shredder as it rotates.

However, depending on the size of the paper, the arm of the supply device in the system disclosed in U.S. Pat. No. 9,669,411 may not reach the paper, and feeding the paper may therefore be difficult.

### SUMMARY

The present invention is directed to solving this problem as described in the following embodiments.

A sheet supply device according to the invention includes: a tray having a support surface on which a sheet is placed; a supplier configured to feed the sheet placed on the support surface; and a discharger from which the sheet is discharged by operation of the supplier. The supplier has multiple rollers disposed separated in the feed direction of the sheet, a rotation driver configured to rotationally drive the multiple rollers, and a roller support supporting the rollers in a direction to and away from the support surface. The sheet placed on the support surface contacts at least one of the multiple rollers and is fed to the discharger by displacement of the roller support.

Another aspect of the invention is a shredding device including: the sheet supply device of the invention; and a shredder that shreds the sheet discharged from the discharger.

Another aspect of the invention is a web forming device including: the shredding device according to the invention; a defibrator configured to defibrate shreds acquired by the operation of the shredder shredding the sheet; and a web former configured to form a web from defibrated material acquired by operation of the defibrator defibrating the shreds.

Yet another aspect of the invention is a sheet recycling system including the web forming device according to the invention, and configured to manufacture a sheet from the web.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic side view illustrating the configuration of a sheet recycling system according to an embodiment of the invention.

FIG. 2 is a schematic side view illustrating the configuration of a sheet supply device according to the invention.

FIG. 3 is a schematic side view illustrating the configuration of a sheet supply device according to the invention.

FIG. 4 is a schematic side view illustrating the configuration of a sheet supply device according to the invention.

FIG. 5 is a perspective view showing main parts of a sheet supply device according to the invention.

FIG. 6 is a schematic side view sequentially illustrating the operation of a sheet supply device according to the invention.

FIG. 7 is a schematic side view sequentially illustrating the operation of a sheet supply device according to the invention.

FIG. 8 is a schematic side view sequentially illustrating the operation of a sheet supply device according to the invention.

FIG. 9 is a schematic side view sequentially illustrating the operation of a sheet supply device according to the invention.

### DESCRIPTION OF EMBODIMENTS

Preferred embodiments of a sheet supply device, a shredding device, a web forming device, and a sheet recycling system according to the invention are described below in detail with reference to the accompanying figures.

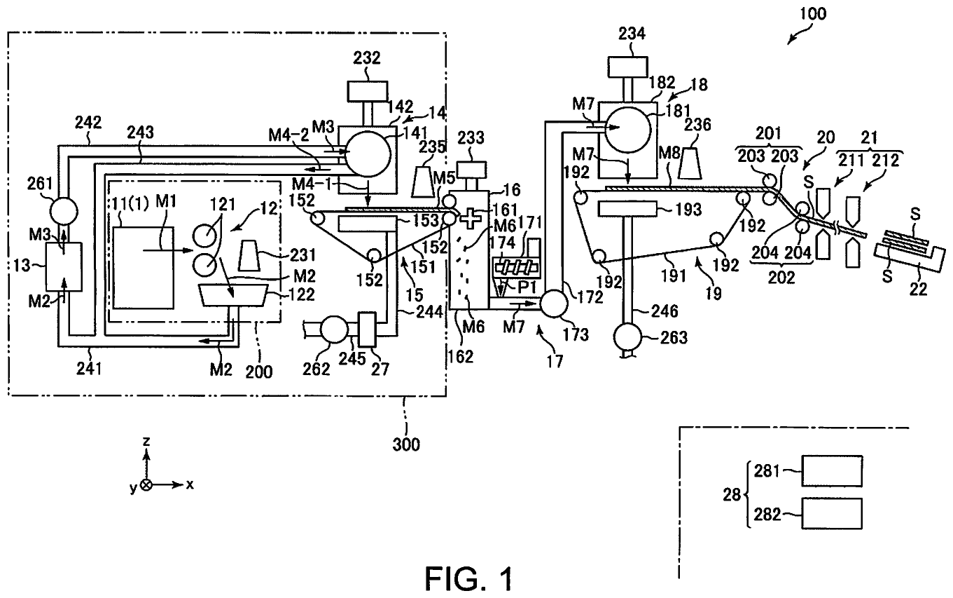

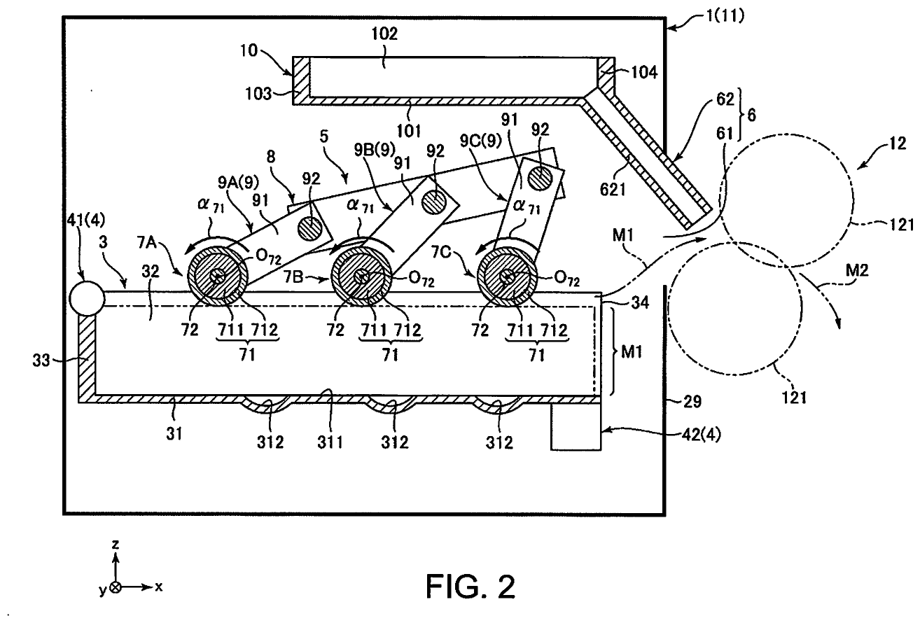

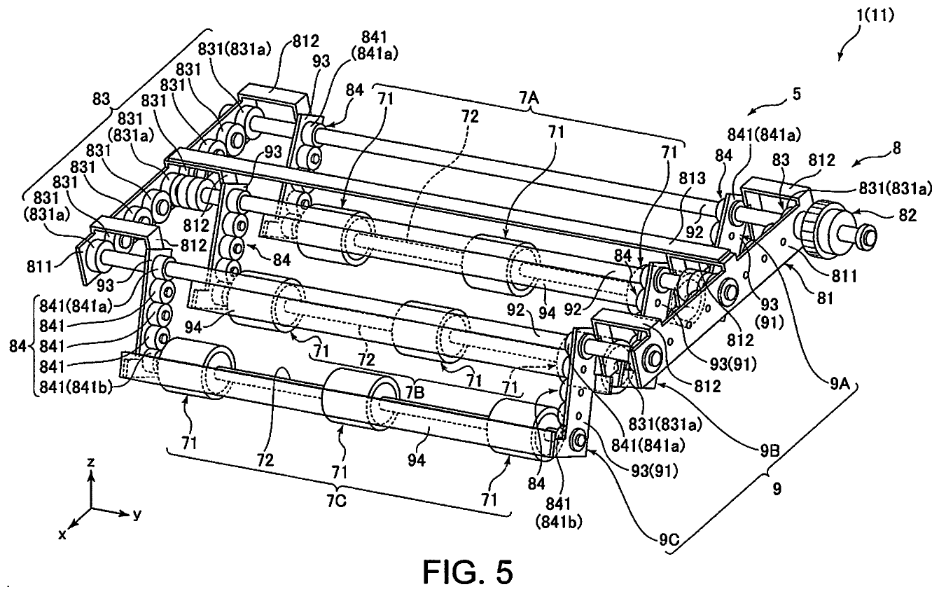

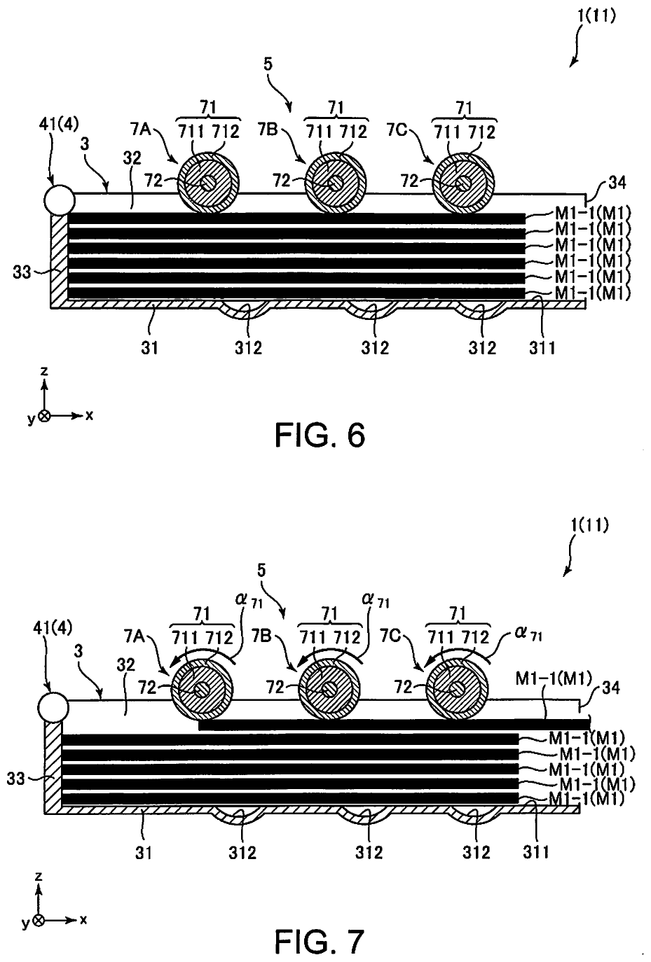

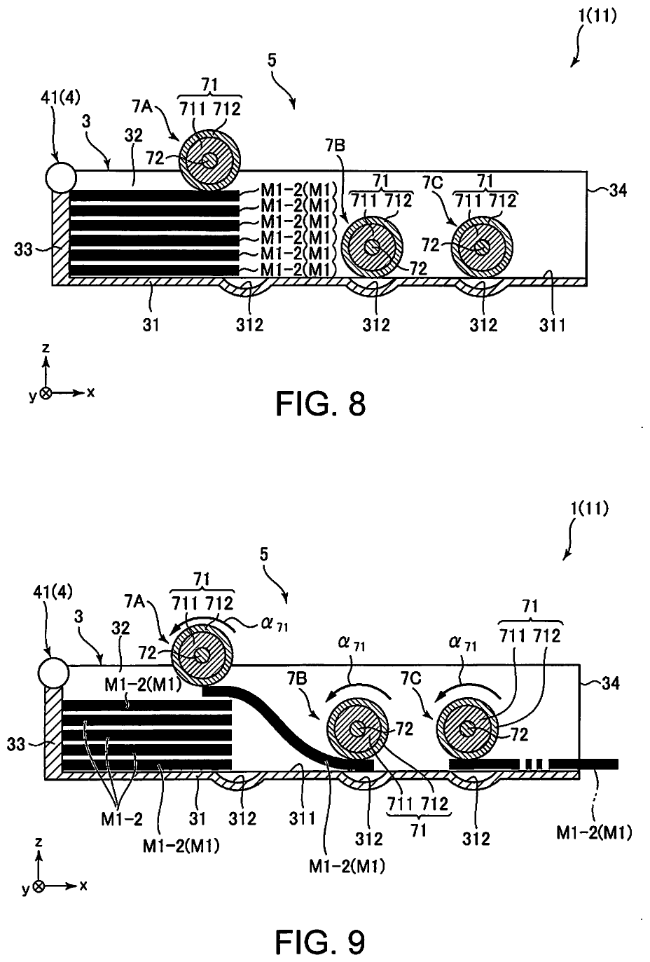

FIG. 1 is a schematic side view illustrating the configuration of a sheet recycling system according to an embodiment of the invention. FIG. 2 to FIG. 4 are schematic side views illustrating the configuration of a sheet supply device according to the invention. FIG. 5 is a perspective view showing main parts of a sheet supply device according to the invention. FIG. 6 and FIG. 7 are schematic side views sequentially illustrating the operation of a sheet supply device according to the invention. FIG. 8 and FIG. 9 are schematic side views sequentially illustrating the operation of a sheet supply device according to the invention.

Note that for convenience below, embodiments of the invention are described with reference to three mutually perpendicular axes, an X-axis, Y-axis, and Z-axis, as shown in FIG. 1. The x-y plane containing the X-axis and Y-axis is horizontal, and the Z-axis is vertical, perpendicular to the x-y plane. The directions indicated by the arrow on each axis is referred to as the forward or positive direction, and the opposite direction as the reverse or negative direction. In addition, in FIG. 1 to FIG. 9 the side at the top is referred to as up or above; and the side at the bottom is referred to as down or below.

As shown in FIG. 1, the sheet supply device 1 of the invention is a device for supplying feedstock M1 of different types and sizes to a downstream shredder 12. As shown in FIG. 2 to FIG. 4, the sheet supply device 1 includes a tray 3 with a support surface 311 on which feedstock M1 (sheets) including sheets of different sizes and types are placed; a supplier 5 that picks and supplies the feedstock M1 (sheets) from above the support surface 311; and a discharger 6 from which the feedstock M1 (sheets) are discharged by operation of the supplier 5.

The supplier 5 includes multiple (in this embodiment, three) rollers 71 separated from each other in the conveyance direction of the feedstock M1 (sheets); a rotation driver 8 that rotationally drives the rollers 71; and a roller support 9 that supports the rollers 71 displaceably toward and away from the support surface 311. At least one roller 71 of the multiple rollers 71 can contact the feedstock M1 (sheets) on the support surface 311, and feed the feedstock M1 (sheets) to the discharger 6.

As described below, this configuration enables at least one roller 71 of the multiple rollers 71 to easily contact the feedstock M1 regardless of what size or type of feedstock M1 is placed in the tray 3. The feedstock M1 can then be sequentially delivered downstream by operating the rollers 71 with at least one roller 71 in contact with the feedstock M1. This enables the sheet supply device 1 to accommodate a wide range of sizes and types of feedstock M1 when feeding the feedstock M1 downstream, and enables smoothly supplying the feedstock M1 downstream.

The sheet supply device 1 can also feed the feedstock M1 by the cooperation of multiple rollers 71. As a result, the rollers 71 can be smaller than when only one roller 71 is used to feed the feedstock M1. This also helps reduce the overall size of the sheet supply device 1.

As shown in FIG. 1, the shredding device 200 of the invention includes the sheet supply device 1 and a shredder 12 that shreds the feedstock M1 (sheets) discharged from the discharger 6 of the sheet supply device 1.

As a result, feedstock M1 can be shredded while reaping the benefits of the sheet supply device 1 described above, and the resulting shreds M2 can be recycled into new sheets S, for example.

As shown in FIG. 1, a web forming device 300 according to the invention includes the shredding device 200 described above, a defibrator 13 that defibrates the shreds M2 (shredded feedstock) acquired by shredding the feedstock M1 (sheets) by operation of the shredder 12 of the shredding device 200, and a first web former 15 (web former) that forms a first web M5 (web) from the defibrated material M3 acquired by the defibrator 13 defibrating the shreds M2 (shredded feedstock).

As a result, recycled sheets S can be formed using the first web M5 while reaping the benefits of the shredding device 200 described above.

As shown in FIG. 1, a sheet recycling system (recovered paper recycling system) 100 according to the invention includes the web forming device 300, and is configured as a sheet manufacturing apparatus capable of making the first web M5 (web) into recycled sheets S.

As a result, recycled sheets S can be formed (manufactured) while reaping the benefits of the web forming device 300 described above.

As shown in FIG. 1, the sheet recycling system 100 includes a feedstock supply device 11, a shredder 12, a defibrator 13, a classifier 14, a first web former 15, a cutter 16, a mixing device 17, a detangler 18, a second web former 19, a sheet former 20, a sheet cutter 21, a stacker 22, and a dust collector 27. The sheet recycling system 100 also has wetting unit 231, wetting unit 232, wetting unit 233, wetting unit 234, wetting unit 235, and wetting unit 236. The sheet recycling system 100 also has a blower 261, blower 262, and blower 263. In this embodiment of the invention the feedstock supply device 11 is configured by the sheet supply device 1.

The sheet recycling system 100 also has wetting unit 231, wetting unit 232, wetting unit 233, wetting unit 234, wetting unit 235, and wetting unit 236. The sheet recycling system 100 also has a blower 261, blower 262, and blower 263.

Parts of the sheet recycling system 100 (sheet supply device 1), such as the rotation driver 8 of the supplier 5 in the sheet supply device 1, are electrically connected to a controller 28. Operation of those parts is controlled by the controller 28.

The controller 28 includes a CPU (central processing unit) 281 and storage 282. The CPU 281 can make various decisions and assert commands. The storage 282 stores programs, including a program controlling sheet S manufacturing. This controller 28 may be built into the sheet recycling system 100, or disposed to an external device such as an externally connected computer. The external device may connect to and communicate with the sheet recycling system 100 through a cable or wirelessly, or connect to the sheet recycling system 100 through a network (such as the Internet).

The CPU 281 and storage 282 may be integrated and configured as a single unit, or the CPU 281 may be incorporated in the sheet recycling system 100 with the storage 282 disposed to an external computer or other external device, or the storage 282 may be incorporated in the sheet recycling system 100 with the CPU 281 disposed to an external computer or other external device.

The sheet recycling system 100 executes, in order, a feedstock supply process, a shredding process, a defibrating process, a classification process, a first web forming process, a cutting process, a mixing process, a detangling process, a second web forming process, a sheet forming process, and a sheet cutting process.

The configurations of selected parts are described below.

The feedstock supply device 11 is the part that executes the feedstock supply process supplying feedstock M1 (sheets) to the shredder 12. The feedstock M1 is a sheet material containing fiber (cellulose fiber).

The cellulose fiber may be any fibrous material containing mainly cellulose (narrowly defined cellulose) as a chemical compound, and in addition to cellulose (narrowly defined cellulose) may include hemicellulose or lignin. The form of the feedstock M1 is not specifically limited, and it may be woven cloth or non-woven cloth. The feedstock M1 may also be recycled paper manufactured (recycled) by defibrating recovered paper, for example, or synthetic Yupo paper (R), and does not need to be recycled paper. In this embodiment, the feedstock M1 is previously used recovered paper.

The shredder 12 is the part that executes the shredding process of shredding the feedstock M1 supplied from the feedstock supply device 11 in air (ambient air). The shredder 12 has a pair of shredder blades 121 and a chute (hopper) 122.

Note that in this embodiment the shredding device 200 is configured by the elements through the shredder 12. In other words, the shredding device 200 includes the feedstock supply device 11 and the shredder 12.

By turning in mutually opposite directions of rotation, the pair of shredder blades 121 shred the feedstock M1 passing therebetween, that is, cut the feedstock M1 into small shreds M2. The size and shape of the shreds M2 are preferably appropriate to the defibration process of the defibrator 13, and in this example are preferably pieces 100 mm or less on a side, and are further preferably pieces that are greater than or equal to 10 mm and less than or equal to 70 mm per side.

The chute 122 is located below the pair of shredder blades 121, and in this example is funnel-shaped. As a result, the chute 122 can easily catch the shreds M2 that are shredded and dropped by the shredder blades 121.

Above the chute 122, a wetting unit 231 is disposed beside the pair of shredder blades 121. The wetting unit 231 wets the shreds M2 in the chute 122. This wetting unit 231 has a filter (not shown in the figure) containing water, and is configured as a heaterless humidifier (or heated humidifier) that supplies a moist stream of air to the shreds M2 by passing air through the filter. By wet air being supplied to the shreds M2, accumulation of shreds M2 on the chute 122 due to static electricity can be suppressed.

The chute 122 connects to the defibrator 13 through a conduit (flow channel) 241. The shreds M2 collected in the chute 122 passes through the conduit 241 and are conveyed to the defibrator 13.

The defibrator 13 is the part that executes the defibrating process (see FIG. 5) that defibrates the shreds M2 in a dry process in air. Defibrated material M3 can be produced from the shreds M2 by the defibration process of the defibrator 13.

As used herein, defibrate means to break apart and detangle into single individual fibers shreds M2 composed of many fibers bonded together. The resulting detangled fibers are the defibrated material M3. The shape of the defibrated material M3 is strands and ribbons. The defibrated material M3 may also contain clumps, which are multiple fibers tangled together into clumps.

In this example the defibrator 13 is configured as an impeller mill having a rotor that turns at high speed, and a liner disposed around the outside of the rotor. The shreds M2 flowing into the defibrator 13 pass between the rotor and the liner and are defibrated.

The defibrator 13 also produces, by rotation of the rotor, a flow of air (an air current) from the shredder 12 to the classifier 14. As a result, the shreds M2 can be suctioned from the conduit 241 into the defibrator 13. The defibrated material M3 can also be fed through conduit 242 to the classifier 14 after defibration.

A blower 261 is disposed to the conduit 242. The blower 261 is an air current generator that produces a flow of air to the classifier 14. Conveyance of the defibrated material M3 to the classifier 14 is thereby promoted.

The classifier 14 is the part that executes the classification process of classifying the defibrated material M3 based on the length of the fibers. In the classifier 14, the defibrated material M3 is separated into first screened material M4-1, and second screened material M4-2 that is larger than the first screened material M4-1. The first screened material M4-1 is of a size appropriate to manufacturing sheets S downstream.

The average length of the fibers is preferably greater than or equal to 1 μm and less than or equal to 30 μm.

The second screened material M4-2 includes, for example, fiber that has not been sufficiently defibrated, and excessively agglomerated (clumped) defibrated fibers.

The classifier 14 includes a drum 141, and a housing 142 enclosing the drum 141.

The drum 141 is a sieve comprising a cylindrical mesh body that rotates on its center axis. The defibrated material M3 is introduced to the drum 141. By the drum 141 rotating, defibrated material M3 that is smaller than the mesh passes through and is separated as first screened material M4-1, and defibrated material M3 that is larger than the mesh and therefore does not pass through, is separated as second screened material M4-2.

The first screened material M4-1 drops from the drum 141.

The second screened material M4-2 is discharged to the conduit (flow path) 243 connected to the drum 141. The end of the conduit 243 on the opposite end (downstream end) as the drum 141 is connected to another conduit 241. The second screened material M4-2 that passes through the conduit 243 merges with the shreds M2 inside the conduit 241, and is introduced with the shreds M2 to the defibrator 13. As a result, the second screened material M4-2 is returned to the defibrator 13 and passes through the defibrating process with the shreds M2.

The first screened material M4-1 from the drum 141 is dispersed while dropping through air, and descends toward the first web former 15 (separator) located below the drum 141. The first web former 15 is the part that executes a first web forming process forming a first web M5 by accumulating the first screened material M4-1. The first web former 15 includes a mesh belt (separation belt) 151, three tension rollers 152, and a suction unit (suction mechanism) 153.

In this embodiment, the elements through the first web former 15 configure the web forming device 300. More specifically, the web forming device 300 includes the feedstock supply device 11, shredder 12, defibrator 13, classifier 14, and first web former 15. Note that the configuration of the web forming device 300 is not limited to this configuration, and may be configured without the classifier 14, or may also be configured to include the cutter 16, mixing device 17, detangler 18, and second web former 19.

The mesh belt 151 is an endless belt on which the first screened material M4-1 accumulates. This mesh belt 151 is mounted on three tension rollers 152. By rotationally driving the tension rollers 152, the first screened material M4-1 deposited on the mesh belt 151 is conveyed downstream.

The size of the first screened material M4-1 is greater than or equal to the size of the mesh in the mesh belt 151. As a result, passage of the first screened material M4-1 through the mesh belt 151 is limited, and as a result the first screened material M4-1 accumulates on the mesh belt 151. Furthermore, because the first screened material M4-1 is conveyed downstream by the mesh belt 151 as the first screened material M4-1 accumulates on the mesh belt 151, the first screened material M4-1 is formed in a layer as a first web M5.

The first screened material M4-1 may also contain dust and dirt, for example. The dust and dirt may be produced during shredding and defibration. Such dust and dirt is later recovered by the dust collector 27 described below.

The suction unit 153 suctions air from below the mesh belt 151. As a result, dust and dirt that passes through the mesh belt 151 can be suctioned with the air.

The suction unit 153 is connected to a dust collector 27 (recovery device) through another conduit (flowpath) 244. Dust and dirt suctioned by the suction unit 153 is captured by the dust collector 27.

Another conduit (flow path) 245 is also connected to the dust collector 27. A blower 262 is disposed to the conduit 245. Operation of the blower 262 produces suction in the suction unit 153. This promotes formation of the first web M5 on the mesh belt 151. Dust and dirt are therefore removed from the material forming the first web M5. Operation of the blower 262 causes the dust and dirt to pass through the conduit 244 to the dust collector 27.

The housing 142 is connected to a wetting unit 232. Like the wetting unit 231 described above, the wetting unit 232 is a heaterless humidifier. As a result, humidified air is supplied into the housing 142. This wet air moistens the first screened material M4-1, and as a result can suppress accretion of the first screened material M4-1 on the inside walls of the housing 142 due to static electricity.

Another wetting unit 235 is disposed downstream from the classifier 14. This wetting unit 235 is configured as an ultrasonic humidifier that mists water. As a result, moisture can be supplied to the first web M5, and the moisture content of the first web M5 can thereby be adjusted. This adjustment can also suppress accretion of the first web M5 on the mesh belt 151 due to static electricity. As a result, the first web M5 easily separates from the mesh belt 151 at the tension roller 152 from where the mesh belt 151 returns to the upstream side.

On the downstream side of the wetting unit 235 is a cutter 16. The cutter 16 is a part that executes a cutting process of cutting the first web M5 that has separated from the mesh belt 151.

The cutter 16 has a propeller 161 that is rotationally supported, and a housing 162 that houses the propeller 161. The first web M5 is cut into pieces as it is fed into the rotating propeller 161. The cut first web M5 is thus processed into fragments M6. The fragments M6 then drop down in the housing 162.

The housing 162 is connected to another wetting unit 233. Like wetting unit 231 described above, wetting unit 233 is a heaterless humidifier. As a result, humidified air is supplied into the housing 162. This wet air suppresses sticking of the fragments M6 to the propeller 161 and to the inside walls of the housing 162 due to static electricity.

A mixing device 17 is disposed on the downstream side of the cutter 16. The mixing device 17 is the part that executes a mixing process of mixing the fragments M6 with resin P1. The mixing device 17 includes a resin supply device 171, a conduit (flow path) 172, and a blower 173.

The conduit 172 connects the housing 162 of the cutter 16 to the housing 182 of the detangler 18, and is a flow path through which a mixture M7 of the fragments M6 and resin P1 passes.

The resin supply device 171 connects to the conduit 172. The resin supply device 171 has a screw feeder 174. By rotationally driving the screw feeder 174, the resin P1 can be supplied in powder or particle form to the conduit 172. The resin P1 supplied to the conduit 172 is mixed with the fragments M6, forming the mixture M7.

Note that the resin P1 bonds fibers together in a downstream process, and may be a thermoplastic resin or a thermosetting resin, but is preferably a thermoplastic resin. Examples of such thermoplastic resins include AS resin, ABS resin, polyethylene, polypropylene, ethylene-vinylacetate copolymer (EVA), or other polyolefin, denatured polyolefins, polymethylmethacrylate or other acrylic resin, polyvinyl chloride, polystyrene, polyethylene terephthalate, polybutylene terephthalate or other polyesters, nylon 6, nylon 46, nylon 66, nylon 610, nylon 612, nylon 11, nylon 12, nylon 6-12, nylon 6-66 or other polyimide (nylon), polyphenylene ether, polyacetal, polyether, polyphenylene oxide, polyether ether ketone, polycarbonate, polyphenylene sulfide, thermoplastic polyimide, polyether imide, aromatic polyester, or other liquid crystal polymer, styrenes, polyolefins, polyvinyl chlorides, polyurethanes, polyesters, polyimides, polybutadienes, transpolyisoprenes, fluoroelastomers, polyethylene chlorides and other thermoplastic elastomers, as well as combinations of one or two or more of the foregoing. Preferably, a polyester or resin containing a polyester is used as the thermoplastic resin.

Additives other than resin P1 may also be supplied from the resin supply device 171, including, for example, coloring agents for adding color to the fiber, anti-blocking agents for suppressing clumping of the fiber and clumping of the resin P1, flame retardants for making the fiber and manufactured sheets difficult to burn, and paper strengtheners for increasing the strength of the sheet S. Compounds already incorporating such other additives with the resin P1 may also be supplied.

The blower 173 is disposed to the conduit 172 downstream from the resin supply device 171. The fragments M6 and resin P1 are also mixed by the action of a rotating unit such as blades of the blower 173.

The blower 173 is configured to produce an air current toward the detangler 18. This air current can also mix the fragments M6 and resin P1 inside the conduit 172. As a result, the mixture M7 can be introduced to the detangler 18 as a uniform dispersion of the fragments M6 and resin P1. The fragments M6 in the mixture M7 are further detangled into smaller fibers while travelling through the conduit 172.

The detangler 18 is the part that executes the detangling process that detangles interlocked fibers in the mixture M7.

The detangler 18 includes a drum 181 and a housing 182 that houses the drum 181.

The drum 181 is a sieve comprising a cylindrical mesh body that rotates on its center axis. The mixture M7 is introduced to the drum 181. By the drum 181 rotating, fiber in the mixture M7 that is smaller than the mesh can pass through the drum 181. The mixture M7 is detangled in this process.

The mixture M7 that is detangled in the drum 181 is dispersed while dropping through air, and falls to the second web former 19 located below the drum 181. The second web former 19 is the part that executes the second web forming process forming a second web M8 from the mixture M7. The second web former 19 includes a mesh belt (separation belt) 191, tension rollers 192, and a suction unit (suction mechanism) 193.

The mesh belt 191 is an endless belt on which the mixture M7 accumulates. This mesh belt 191 is mounted on four tension rollers 192. By rotationally driving the tension rollers 192, the mixture M7 deposited on the mesh belt 191 is conveyed downstream.

Most of the mixture M7 on the mesh belt 191 is larger than the mesh in the mesh belt 191. As a result, the mixture M7 is suppressed from passing through the mesh belt 191, and therefore accumulates on the mesh belt 191. The mixture M7 is conveyed downstream by the mesh belt 191 as the mixture M7 accumulates on the mesh belt 191, and is formed in a layer as the second web M8.

The suction unit 193 can suction air down from below the mesh belt 191. As a result, the mixture M7 can be pulled onto the mesh belt 191, and accumulation of the mixture M7 on the mesh belt 191 is thereby promoted.

Another conduit (flow path) 246 is connected to the suction unit 193. A blower 263 is also disposed to the conduit 246. Operation of the blower 263 produces suction in the suction unit 193.

Note that conduit 241, conduit 242, conduit 243, conduit 244, conduit 245, conduit 246, and conduit 172 may be configured from single conduits, or may be configured from multiple lengths of conduit joined by connectors.

Another wetting unit 234 is connected to the housing 182. Like the wetting unit 231 described above, wetting unit 234 is a heaterless humidifier. As a result, humidified air is supplied into the housing 182. By humidifying the inside of the housing 182 by adding wet air, sticking of the mixture M7 to the inside walls of the housing 182 due to static electricity can be suppressed.

Another wetting unit 236 is disposed below the detangler 18. This wetting unit 236 is configured as an ultrasonic humidifier similarly to the wetting unit 235 described above. As a result, moisture can be supplied to the second web M8, and the moisture content of the second web M8 can thereby be adjusted. Adjusting the moisture content can also suppress sticking of the second web M8 to the mesh belt 191 due to static electricity. As a result, the second web M8 easily separates from the mesh belt 191 at the tension roller 192 from where the mesh belt 191 returns to the upstream side.

Note that the amount of moisture (total moisture content) added by wetting unit 231 to wetting unit 236 is, for example, preferably greater than or equal to 0.5 parts by weight and less than or equal to 20 parts by weight per 100 parts by weight of the material before adding water.

A sheet former 20 is disposed downstream from the second web former 19. The sheet former 20 is the part that executes the sheet forming process forming sheets S from the second web M8. This sheet former 20 includes a calender 201 and a heater 202.

The calender 201 comprises a pair of calender rolls 203, and the second web M8 can be compressed without heating (without melting the resin P1) by passing the second web M8 between the calender rolls 203. This process increases the density of the second web M8. The second web M8 is then conveyed toward the heater 202. Note that one of the pair of calender rolls 203 is a drive roller that is driven by operation of a motor (not shown in the figure), and the other is a driven roller.

The heater 202 has a pair of heat rollers 204, which can heat while compressing the second web M8 passing between the heat rollers 204. The combination of heat and pressure melts the resin P1 in the second web M8, and bonds fibers through the molten resin P1. As a result, a sheet S is formed.

The sheet S is then conveyed to the paper cutter 21. Note that one of the pair of heat rollers 204 is a drive roller that is driven by operation of a motor (not shown in the figure), and the other is a driven roller.

A paper cutter 21 is disposed downstream from the sheet former 20. The paper cutter 21 is the part that executes the sheet cutting process that cuts the continuous sheet S into single sheets S. The paper cutter 21 includes a first cutter 211 and a second cutter 212.

The first cutter 211 cuts the sheet S in the direction crosswise to the conveyance direction of the sheet S.

The second cutter 212 is downstream from the first cutter 211, and cuts the sheets S in the direction parallel to the conveyance direction of the sheet S.

Sheets S of a desired size are produced by the cutting action of the first cutter 211 and the second cutter 212. The sheets S are then conveyed further downstream and stacked in a stacker 220.

As described above, the feedstock supply device 11 in this embodiment is configured by the sheet supply device 1. However, the feedstock M1 supplied from the sheet supply device 1 is recovered paper that has already been used. As a result, different sizes and types of sheets may be included in the feedstock M1. The ability to handle and supply a wide range of sizes and types of feedstock M1 is therefore desirable. The sheet supply device 1 is a supply mechanism that accommodates a wide range of sizes and types of feedstock M1.

The sheet supply device 1 is further described below.

As shown in FIG. 2 to FIG. 4, the sheet supply device 1 includes a tray 3 (first tray) on which the feedstock M1 is placed; a tray support 4 displaceably supporting the tray; a supplier 5 that feeds the feedstock M1 downstream from the tray; a discharger 6 from which the feedstock M1 is discharged; and a manual feed tray 10 (second tray). The configurations of these parts are described below.

Note that below the direction in which the feedstock M1 is fed by the supplier 5 is referred to as the feed direction.

The tray 3 is a stacker comprising a bottom 31, side walls 32 rising from the Y-axis sides of the bottom 31, and a back wall 33 rising from the back end (the upstream end) of the bottom 31 in the feed direction. The front end (the downstream end) of the tray 3 in the feed direction is an opening 34 to the downstream in the feed direction.

The bottom 31 is a flat panel, the top surface of which is the support surface 311 on which the feedstock M1 is placed. Multiple sheets of feedstock M1 can be placed in a stack on the support surface 311. The multiple sheets of feedstock M1 may include unused paper, for example, in addition to recovered paper. The area of the support surface 311 is sufficient to accommodate feedstock M1 regardless of the size and type of the feedstock M1.

The side walls 32 and back wall 33 are disposed along the edges of the bottom 31. The side walls 32 and back wall 33 are substantially the same height, and are disposed to enclose the bottom 31. As a result, the feedstock M1 placed on the tray 3 (bottom 31) can be prevented from protruding from the tray 3. Note that the maximum height of the stack of feedstock M1 on the tray 3 is preferably the same as or lower than the height of the side walls 32 and back wall 33.

The feedstock M1 held in the tray 3 can be fed by the supplier 5 from the opening 34 to the discharger 6.

The tray 3 is configured to be removably installed in the sheet supply device 1. In other words, the tray 3 may be configured like a paper cassette.

As shown in FIG. 2 to FIG. 4, the tray 3 is supported by the tray support 4 so that the height of the support surface 311 can change according to the amount of feedstock M1 (total weight of the feedstock M1). The tray support 4 has a support pivot 41 that rotationally supports the upstream end of the tray 3 in the feed direction, that is, the back wall 33; and an urging member 42 that upwardly urges the downstream end of the tray 3 in the feed direction, that is, the opening 34 end.

The tray 3 can pivot on the rotational axis of the support pivot 41 (axis of rotation). As a result, the support surface 311 of the tray 3 becomes inclined to the x-y plane, and the height (position on the Z-axis) changes according (proportionally) to the angle of inclination θ₃₁₁.

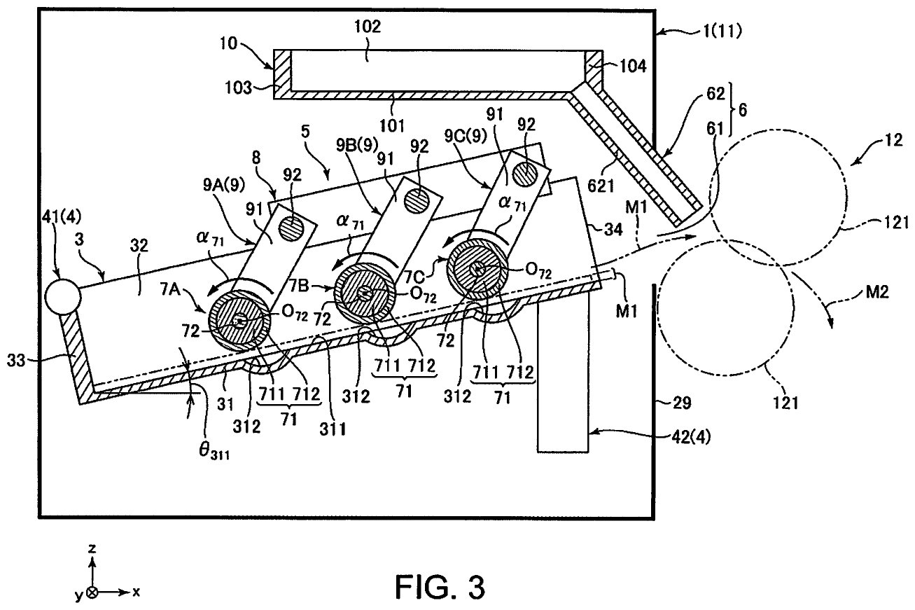

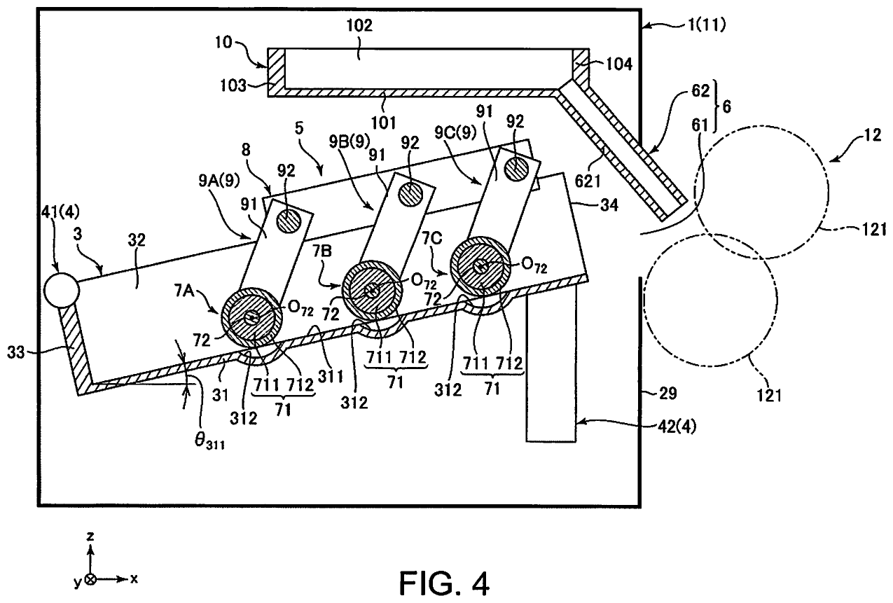

If the angle of inclination θ₃₁₁ is zero, the tray 3 is in a first position with the support surface 311 parallel to the x-y plane as shown in FIG. 2. When the angle of inclination θ₃₁₁ is at the maximum, the tray 3 is in a second position with the support surface 311 at the greatest incline as shown in FIG. 4. The tray 3 can also go to a position (such as shown in FIG. 3) between the position shown in FIG. 2 and the position shown in FIG. 4. By the tray 3 moving to these positions according to the amount of feedstock M1, the distance between the topmost sheet of feedstock M1 on the tray 3 and the discharger 6 can be kept as short as possible and held substantially constant regardless of the total weight of the feedstock M1. As a result, the feedstock M1 can be stably supplied to the discharger 6 (see FIG. 2 and FIG. 3).

The urging member 42 in this example is a compression spring. Because the weight of the feedstock M1 is greatest when in the position shown in FIG. 2, the tray 3 moves to the first position in resistance to the urging force of the urging member 42.

As feedstock M1 is fed downstream from the position in FIG. 2, the weight of the feedstock M1 gradually decreases as the feedstock M1 is fed out. As a result, the urging force of the urging member 42 surpasses the gravitational force on the tray 3, and the tray 3 moves from the position shown in FIG. 2 to an inclined position as shown in FIG. 3.

As feeding the feedstock M1 continues from the position shown in FIG. 3, all of the feedstock M1 eventually is supplied from the tray 3. The urging force of the urging member 42 therefore further exceeds the gravitational force acting on the tray 3, and the tray 3 moves from the position shown in FIG. 3 to the further inclined position as shown in FIG. 4.

As described above, the sheet supply device 1 has a tray support 4 that supports the tray 3 so the height of the support surface 311 can change. The tray support 4 is configured to pivotably support the end of the tray 3 upstream in the feed direction. As a result, as described above, the tray 3 can go to a first position (horizontal position), a second position (maximum incline position), and a position between the first position and second position (an inclined position). The tray 3 can also move between these positions according to the amount (weight) of feedstock M1, and thereby holds the feedstock M1 on the tray 3 positioned desirably in relation to the discharger 6.

Note that the tray support 4 is configured in this embodiment so that the angle of inclination θ₃11 of the tray 3 can change, but the invention is not so limited. More particularly, the tray support 4 may be configured so that the entire tray 3 can move vertically up and down.

The manual feed tray 10 is disposed above, that is, on the positive Z-axis side, of the tray 3. The manual feed tray 10 enables manually supplying feedstock M1 one sheet at a time to the discharger 6 separately from tray 3.

The manual feed tray 10 has a bottom 101, side walls 102 rising from the Y-axis sides of the bottom 101, a back wall 103 on the negative X-axis side of the bottom 101, and a front wall 104 rising from the positive X-axis side of the bottom 101.

The bottom 101 is a flat panel parallel to the x-y plane. The side walls 102, back wall 103, and front wall 104 are disposed along the edges of the bottom 101. The side walls 102, back wall 103, and front wall 104 are substantially the same height, and are disposed to enclose the bottom 101.

The discharger 6 is divided into a first discharge part 61 and a second discharge part 62. The first discharge part 61 is the part from which feedstock M1 on the tray 3 is discharged by operation of the supplier 5. The second discharge part 62 is the part where feedstock M1 is discharged from the manual feed tray 10.

The shredder 12 that shreds the feedstock M1 discharged from the discharger 6 is located downstream in the feed direction from the discharger 6. Feedstock M1 discharged from the first discharge part 61, and feedstock M1 discharged from the second discharge part 62, are both cut by the shredder 12 into shreds M2.

The first discharge part 61 in this example is configured by an opening formed in the housing 29 of the sheet supply device 1 to open to the positive X-axis side. The first discharge part 61 faces the space between the two shredder cutters 121 of the shredder 12. As a result, the feedstock M1 discharged from the first discharge part 61 is shredded between the two shredder cutters 121, forming shreds M2.

The second discharge part 62 is formed protruding at an incline from the boundary between the bottom 101 and the front wall 104 of the manual feed tray 10 to the space between the two shredder cutters 121 of the shredder 12. The second discharge part 62 is configured as a hollow flat member that communicates with the manual feed tray 10. As a result, the feedstock M1 discharged from the second discharge part 62 is shredded between the two shredder cutters 121, forming shreds M2.

As described above, the shredder 12 that shreds feedstock M1 (sheets) discharged from the discharger 6 is disposed on the downstream in the feed direction from the discharger 6. The discharger 6 also has a second discharge part 62 that functions as a guide to guide feedstock M1 (sheets) from the tray 3 to the shredder 12.

The feedstock M1 on the tray 3 normally moves toward the first discharge part 61 when discharged by operation of the supplier 5, but if the feedstock M1 is curled, for example, directing the feedstock M1 to the first discharge part 61 may be difficult. In this event, when advanced by operation of the supplier 5, the feedstock M1 on the tray 3 contacts the outside bottom surface 621 of the second discharge part 62, and can be thereby directed in the direction of the downward slope of the outside bottom surface 621. As a result, the feedstock M1 can pass through the first discharge part 61, proceed to the shredder 12, and then be shredded by the shredder 12.

Note that the outside shape of the second discharge part 62 is not limited to the shape shown in FIG. 2 to FIG. 4, and may have a return (protrusion) projecting to the tray 3 side.

The supplier 5 conveys feedstock M1 loaded on the tray 3 (support surface 311) one sheet at a time downstream, that is, towards the discharger 6. As shown in FIG. 2 to FIG. 4, the supplier 5 includes a first roller mechanism 7A, a second roller mechanism 7B, a third roller mechanism 7C, the rotation driver 8, and the roller support 9.

The first roller mechanism 7A, second roller mechanism 7B, and third roller mechanism 7C are disposed spaced along the feed direction respectively in order from the upstream side in the feed direction, that is, the negative X-axis end. Except for being at different positions, the roller mechanisms are identically configured, and are therefore described below using the third roller mechanism 7C at the positive X-axis end by way of example.

Note that the number of roller mechanisms in the supplier 5 is three in this embodiment, but the invention is not so limited and there may be two, or four or more.

As shown in FIG. 5, the third roller mechanism 7C includes three rollers 71 spaced equidistantly along the Y-axis, and an axle 72 that rotationally supports the three rollers 71.

Note that the number of rollers 71 in the first roller mechanism 7A is three in this example, but the invention is not so limited and may include one, two, or four or more rollers 71. The length of the rollers 71 is preferably adjusted appropriately according to the number of rollers 71.

The axle 72 is disposed parallel to the Y-axis, and is configured by a rod that is round in cross section.

The three rollers 71 are affixed to the axle 72 with equal spacing therebetween. Each of the rollers 71 can rotate in the direction of arrow α₇₁ around the axis of rotation O₇₂ of the axle 72. The rollers 71 can feed the feedstock M1 by rotating in the direction of arrow α₇₁ in contact with the feedstock M1.

The rollers 71 in this example comprise a cylindrical core 711 and an elastic layer 712 disposed around the outside of the core 711.

The core 711 is made from a hard material such as stainless steel or ABS resin.

An elastic layer 712 made from an elastic material is affixed to the outside of the core 711. The elastic material is not specifically limited, and may be urethane rubber or other type of rubber, styrene or other type of thermoplastic elastomer, or a combination of one or two or more such materials. As a result, when feeding the feedstock M1, the rollers 71 can be prevented from slipping against the feedstock M1 and turning idly, and can thereby more consistently feed the feedstock M1. The elastic layer 712 may also be textured with small bumps or grooves. This can help further prevent slipping against the feedstock M1.

The rollers 71 are also not limited to the same material, and maybe configured from different materials and surface textures that differ according to the type of paper (feedstock M1). As a result, individual rollers 71 can be configured with different coefficients of friction, and skewed feeding of the paper (feedstock M1) can be reduced.

The roller 71 of the first roller mechanism 7A, the rollers 71 of the second roller mechanism 7B, and the rollers 71 of the third roller mechanism 7C all have the same diameter in this embodiment of the invention, but the invention is not so limited and the outside diameters may be different.

When the outside diameters are different, the diameter of the rollers 71 of the first roller mechanism 7A is preferably greatest, the diameter of the rollers 71 of the third roller mechanism 7C is preferably smallest, and the diameter of the rollers 71 of the second roller mechanism 7B is preferably inbetween. As a result, the conveyance speed of the feedstock M1 by the third roller mechanism 7C furthest downstream in the feed direction is greatest.

The supplier 5 is thus configured so that the conveyance speed of the feedstock M1 by the rollers 71 on the downstream side in the feed direction is faster than the conveyance speed of the feedstock M1 by the rollers 71 on the upstream side in the feed direction. This configuration can prevent the feedstock M1 becoming jammed (paper jam) while feeding the feedstock M1, and can thereby consistently and smoothly feed the feedstock M1.

The roller support 9 supports the first roller mechanism 7A, second roller mechanism 7B, and third roller mechanism 7C displaceably in the directions moving to and away from the support surface 311 of the tray 3. As shown in FIG. 5, the roller support 9 has a first support 9A that supports the first roller mechanism 7A, a second support 9B that supports the second roller mechanism 7B, and a third support 9C that supports the third roller mechanism 7C.

Except for being at different positions, the supports are identically configured, and are therefore described below using the third support 9C that supports the third roller mechanism 7C by way of example.

The third support 9C has an arm 91 that supports both ends of the axle 72 of the third roller mechanism 7C, and an axle 92 that supports the arm 91 at the opposite end as the third roller mechanism 7C.

The axle 92 is disposed parallel to the Y-axis, and is configured by a rod that is round in cross section.

The arm 91 is supported at one end by the axle 92. The arm 91 includes two plates 93 separated from each other along the length of the axle 92, and a connector 94 that connects the plates 93.

The axle 92 passes through both plates 93, and is supported by a clearance fit (lightly fit) to the axle 92. As a result, the arm 91 can pivot around the axle 92. Because the arm 91 is supported by a clearance fit to the axle 92, the axle 92 does not turn with the arm 91.

Of the two plates 93, one arm plate 93 (on the left side in FIG. 5) supports the one end of the axle 72 of the third roller mechanism 7C, and the other arm plate 93 (on the right side in FIG. 5) supports the other end of the axle 72 of the third roller mechanism 7C. As a result, the axle 72 of the third roller mechanism 7C is supported at both ends.

The roller support 9 thus has an axle 92 as a pivot support member that supports the rollers 71 independently rotatably on an axis of rotation at a position separated above (in the direction to which multiple sheets of feedstock M1 (sheets) are stacked on the support surface 311) the axis of rotation O₇₂, which is the axis of rotation of the rollers 71 in each roller mechanism (first roller mechanism 7A to third roller mechanism 7C). As a result, the rollers 71 of each roller mechanism can also displace, independently in each roller mechanism, in the directions moving to and away from the support surface 311 of the tray 3 (see FIG. 2 to FIG. 4).

The maximum angle of rotation of the third roller mechanism 7C around the axle 92 is preferably less than or equal to 180 degrees, and further preferably greater than or equal to 60 degrees and less than or equal to 100 degrees. The same applies to the first roller mechanism 7A and second roller mechanism 7B.

Regardless of the amount of rotation (angle of rotation) of the third roller mechanism 7C, the axle 92 is also preferably located on the positive X-axis side of the axle 72.

The supplier 5 may also have a limiter that determines the limit of third roller mechanism 7C rotation. This limiter is not specifically limited, and may be configured by a stop that engages the arm 91 at the rotational limit (the position at the maximum angle of rotation) of the third roller mechanism 7C.

The supplier 5 may also have an adjuster that adjusts the contact pressure of the first roller mechanism 7A against the feedstock M1 when the roller 71 contacts the feedstock M1. This adjuster is not specifically limited, and may be configured by an urging member (a coil spring) that applies an upward or downward urging force on the roller 71 through the arm 91.

The supplier 5 (roller support 9) is also preferably configured so that the rollers 71 separate from the support surface 311 when placing feedstock M1 on the tray 3. This enables easily loading feedstock M1 into the tray 3.

The tray 3 also preferably has an escape 312 formed in the support surface 311 that prevents interference with the rollers 71 when the rollers 71 of the corresponding roller mechanism (first roller mechanism 7A to third roller mechanism 7C) are closest to the support surface 311. As a result, if the rollers 71 rotate when there is no feedstock M1 on the tray 3 as shown in FIG. 4, wear on the elastic layer 712 caused by the elastic layer 712 of the roller 71 rotating in contact with the support surface 311 can be prevented. Note that the escape 312 in this example is a recess, but the invention is not so limited and may be a roller (follower roller) that contacts the roller 71 and rotates in unison with the roller 71.

The rotation driver 8 drives the rollers 71 of the first roller mechanism 7A to third roller mechanism 7C at the same time. This rotation feeds the feedstock M1 one sheet at a time. As shown in FIG. 5, the rotation driver 8 includes a frame 81, a drive source 82 such as a motor (not shown in the figure), a first wheel train 83, and a second wheel train 84.

The frame 81 includes two plates 811 separated on the Y-axis; a first connector 812 that connects the plates 811 to the corresponding arm plate 93 of the first support 9A to third support 9C; and a second connector 813 that connects the plates 811 through the first connector 812.

The drive source 82 is configured to produce drive power turning all rollers 71 together. The configuration of the drive source 82 is not specifically limited, but preferably includes a motor, a speed reducer comprising multiple internally engaging gears, or a configuration using pulleys and a timing belt. The size of the sheet supply device 1 can be reduced by using a single drive source 82 (motor) to commonly rotationally drive the rollers 71.

The drive source 82 is not limited to a configuration that commonly (simultaneously) drives the first roller mechanism 7A to third roller mechanism 7C, and may be configured to independently drive the first roller mechanism 7A to third roller mechanism 7C.

The first wheel train 83 and second wheel train 84 are power transfer mechanisms transferring drive power from the drive source 82 to the rollers 71.

The first wheel train 83 is disposed to the plates 811 of the frame 81, and includes multiple first wheels 831 supported rotationally on the plates 811. The number of first wheels 831 in the first wheel trains 83 is nine in the configuration shown in FIG. 5, but the invention is not so limited. The first wheels 831 are disposed along the length of the plates 811, and adjacent first wheels 831 engage each other. The first wheels 831 include a first wheel 831 (first wheel 831a) that is affixed and disposed concentrically to the axle 92 of the roller support 9.

The second wheel train 84 is disposed to each arm plate 93 of the roller support 9, and comprises multiple second wheels 841 rotationally supported by the arm plate 93. The number of second wheels 841 in the second wheel train 84 is five in the example shown in FIG. 5, but is not specifically limited. The second wheels 841 are disposed along the length of the arm plate 93, and adjacent second wheels 841 are mutually engaged. The second wheels 841 include second wheels 841 (second wheels 841a) that are affixed and disposed concentrically to the axle 92 of the roller support 9, and second wheels 841 (second wheels 841b) that are affixed and disposed concentrically to the axle 72 of the corresponding roller mechanism.

The rotation driver 8 thus comprises a drive source 82 that produces drive power to drive the rollers 71; and a first wheel train 83 and second wheel train 84 as drive trains transferring drive power from the drive source 82 to the rollers 71. As a result, the space occupied by the transfer mechanism can be made as small as possible. The size of the sheet supply device 1 can also be reduced by this size reduction and the configuration of the drive source 82 (including the rotational drive source of the roller 71).

The rotation driver 8 may also be configured to stop rotation of the rollers 71 as each sheet of feedstock M1 is fed, that is, to intermittently feed the feedstock M1, but continuously feeding the feedstock M1 is preferable.

If the feedstock M1 is fed intermittently, a detector for detecting sheet by sheet when the feedstock M1 starts to pass and finishes passing through the discharger 6 (first discharge part 61) is preferably provided. Based on the result of this detection, the controller 28 can control (switch) starting and stopping operation of the rotation driver 8.

Note that the detector is not specifically limited, and may be configured to optically detect the presence of feedstock M1, or detect the torque on the rollers 71.

The rotation driver 8 preferably also has a rotational limiter such as a one-way clutch that limits rotation of the rollers 71 in the direction of arrow an and the opposite direction. This configuration enables preventing the feedstock M1 from being pulled in one direction (the downstream direction) and nipped, and thereby enables smoothly and consistently feeding the feedstock M1.

Operation of the sheet supply device 1 thus configured as described above is described next with reference to FIG. 6 to FIG. 9.

As described above, the feedstock M1 supplied from the sheet supply device 1 is previously used recovered paper, and the recovered paper may contain multiple sizes and types of media.

In this example, the largest feedstock M1 that can be supplied from the sheet supply device 1 is referred to as feedstock M1-1 ((see FIG. 6 and FIG. 7), and the smallest feedstock M1 that can be supplied from the sheet supply device 1 is referred to as feedstock M1-2 (see FIG. 8 and FIG. 9). In this example, the feedstock M1-1 is A4 or A3 size plain paper, and feedstock M1-2 is postcard size media.

In the example in FIG. 6, multiple sheets of feedstock M1-1 are loaded on the support surface 311 of the tray 3. In this example, the back ends in the feed direction of the multiple sheets of feedstock M1-1 are preferably aligned in contact with the back wall 33 of the tray 3. In the position shown in FIG. 6, the rollers 71 of the first roller mechanism 7A to third roller mechanism 7C are touching the topmost sheet of feedstock M1-1. As a result, this sheet of feedstock M1 can be fed to the discharger 6.

When the rollers 71 of the first roller mechanism 7A to third roller mechanism 7C then rotate from the position shown in FIG. 6 in the direction of arrow α₇₁, the rollers 71 go to the position shown in FIG. 7. In the position shown in FIG. 7, the topmost sheet of feedstock M1-1 is fed downstream by rotation of the rollers 71.

When feedstock M1-2 is loaded instead of feedstock M1-1, multiple sheets of feedstock M1-2 can be placed on the support surface 311 of the tray 3 as shown in FIG. 8. In this event, the feedstock M1-2 is preferably aligned with the back end in the feed direction against the back wall 33 of the tray 3. Then, as shown in FIG. 8, the rollers 71 of the first roller mechanism 7A in the group of first roller mechanism 7A to third roller mechanism 7C contact the topmost feedstock M1-2 on the stack. As a result, the topmost sheet of feedstock M1-2 can be fed downstream.

When the rollers 71 of the first roller mechanism 7A to third roller mechanism 7C rotate from the position shown in FIG. 8 in the direction of arrow α₇₁, the first roller mechanism 7A can feed the topmost feedstock M1-2 downstream as shown in FIG. 9.

Next, the second roller mechanism 7B adjacent to the first roller mechanism 7A continues feeding the feedstock M1-2 downstream.

Next, the third roller mechanism 7C adjacent to the second roller mechanism 7B can feed the feedstock M1-2 further downstream (see feedstock M1-2 indicated by the dotted line in FIG. 9).

As described above, the rollers 71 of at least one roller mechanism of first roller mechanism 7A to third roller mechanism 7C can contact the feedstock M1 regardless of the amount of feedstock M1 on the support surface 311 of the tray 3. As a result, the feedstock M1 can be fed to the discharger 6. In this configuration, the feedstock M1 can be fed downstream by operation of the first roller mechanism 7A to third roller mechanism 7C.

As a result, the sheet supply device 1 according to this embodiment can smoothly feed feedstock M1 to the shredder 12 regardless of the size and type of the feedstock M1.

A sheet supply device, a shredding device, a web forming device, and a sheet recycling system according to the invention are described above, but the invention is not so limited and parts of the sheet supply device, a shredding device, a web forming device, and a sheet recycling system maybe replaced by configurations of the same function. Desirable additional configurations may also be added.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No: 2018-97864, filed May 22, 2018 is expressly incorporated by reference herein.

What is claimed is:

1. A sheet supply device comprising:
a tray having a support surface on which a sheet is placed;
a supplier configured to feed the sheet placed on the support surface; and
a discharger from which the sheet is discharged by operation of the supplier;
the supplier having multiple rollers disposed separated in the feed direction of the sheet,
a rotation driver configured to rotationally drive the multiple rollers, and
a roller support supporting the rollers in a direction to and away from the support surface;
the sheet placed on the support surface contacting at least one of the multiple rollers and being fed to the discharger by displacement of the roller support.

2. The sheet supply device described in claim 1, wherein:
the roller support has a pivot support with an axis of rotation at a position separated from the axis of rotation of the rollers, and supporting the rollers independently rotationally.

3. The sheet supply device described in claim 2, further comprising:
a tray support supporting the tray so the height of the support surface can change.

4. The sheet supply device described in claim 3, wherein:
the tray support rotationally supports the tray on an upstream side in the feed direction.

5. The sheet supply device described in claim 1, wherein:
the rotation driver includes a drive source that produces drive power causing the rollers to rotate, and a transfer mechanism that transfers the drive power to all rollers.

6. The sheet supply device described in claim 1, wherein:
the tray has an escape disposed in the support surface and preventing interference with the rollers when the rollers are closest to the support surface.

7. The sheet supply device described in claim 1, wherein:
a shredder configured to shred the sheet discharged from the discharger is disposed downstream in the feed direction from the discharger; and
the discharger has a guide that guides the sheet to the shredder.

8. A shredding device comprising:
the sheet supply device described in claim 1; and
a shredder that shreds the sheet discharged from the discharger.

9. A web forming device comprising:
the shredding device described in claim 8;
a defibrator configured to defibrate shreds acquired by the operation of the shredder shredding the sheet; and
a web former configured to form a web from defibrated material acquired by operation of the defibrator defibrating the shreds.

10. A sheet recycling system comprising:
the web forming device described in claim 9; and
configured to manufacture a sheet from the web.
